(19) United States
(12) Patent Application Publication
(10) Pub. No.: US 2024/0405375 A1
(43) Pub. Date: Dec. 5, 2024

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/633,145

(22) Filed: Apr. 11, 2024

(30) Foreign Application Priority Data
May 31, 2023 (JP) 2023-089743

(51) Int. Cl. H01M 50/48; H01M 10/04; H01M 50/474

(52) U.S. Cl. CPC H01M 50/48; H01M 10/0431; H01M 50/474

(57) ABSTRACT

A power storage cell includes a wound electrode assembly which includes a positive plate (a first electrode), a negative plate (a second electrode), and a separator. The positive plate includes a positive current collector (a current collector), a positive electrode mixture layer (an electrode material layer) with which a portion of the positive current collector is coated, a positive tab lead (a tab lead), and an adhesive (a cushioning). The positive tab lead is disposed on an uncoated portion that is not coated with the positive electrode mixture layer. The adhesive is disposed adjacent to the positive tab lead on the uncoated portion.

### CROSS REFERENCE TO RELATED APPLICATIONS

This nonprovisional application is based on Japanese Patent Application No. 2023-089743 filed on May 31, 2023 with the Japan Patent Office, the entire content of which is hereby incorporated by reference.

### BACKGROUND OF THE DISCLOSURE

### Field of the Disclosure

The present disclosure relates to a power storage cell.

### Description of the Background Art

WO2018/105398 discloses a secondary battery that includes an electrode assembly in which a positive electrode and a negative electrode are wound in a spiral manner with a separator in between. A lead, electrically connected to a positive (negative) terminal, is joined to a positive (negative) current collector.

### SUMMARY OF THE DISCLOSURE

In the electrode assembly disclosed in WO2018/105398, the portion of the current collector where the lead is disposed may have an unevenness formed due to the thickness of the lead. In this case, when the wound electrode assembly is confined in a case or the like, a local pressure may be applied to the wound electrode assembly due to the unevenness of the wound electrode assembly.

The present disclosure is made to solve the above problem, and an object of the present disclosure is to provide a power storage cell in which a local pressure is inhibited from being applied to the wound electrode assembly which includes a tab lead.

A power storage cell according to one aspect of the present disclosure includes: a wound electrode assembly which includes a first electrode, a second electrode, and a separator disposed between the first electrode and the second electrode; and a case accommodating the wound electrode assembly. The wound electrode assembly is configured of the first electrode, the second electrode, and the separator which are wound about a winding axis. The first electrode includes: a current collector; an electrode material layer with which a portion of the current collector is coated; a tab lead projecting from the current collector in an axial direction of the wound electrode assembly; and a cushioning. The current collector includes an uncoated portion that is not coated with the electrode material layer. The tab lead is disposed on the uncoated portion. The cushioning is disposed adjacent to the tab lead on the uncoated portion.

In the power storage cell according to the aspect of the present disclosure, the cushioning is disposed adjacent to the tab lead on the uncoated portion, as described above. Owing to this, since the cushioning is disposed on the uncoated portion on which the tab lead is disposed, the area of the uncoated portion where the current collector is exposed can be reduced. As a result, formation of unevenness can be inhibited between the location where the tab lead is disposed and the location where no tab lead is disposed. This can inhibit a local pressure from being applied to the wound electrode assembly due to the unevenness.

In the power storage cell according to the aspect of the present disclosure, preferably, the cushioning has a lower elastic modulus than the tab lead. When the first electrode is unfurled in a form of sheet, a thickness of the cushioning in an orthogonal direction orthogonal to the current collector is greater than or equal to a thickness of the tab lead in the orthogonal direction. With this configuration, since the cushioning has a lower elastic modulus than the tab lead, the cushioning is more likely to deform than the tab lead. Moreover, since the thickness of the cushioning in the orthogonal direction is greater than or equal to the thickness of the tab lead, a difference in thickness between the cushioning and the tab lead can be inhibited from being introduced when the cushioning and the tab lead are deformed by the first electrode being wound.

In this case, preferably, the electrode material layer has a lower elastic modulus than the tab lead. When the first electrode is unfurled in the form of sheet, a thickness of the electrode material layer in the orthogonal direction is greater than or equal to the thickness of the tab lead in the orthogonal direction. With this configuration, since the electrode material layer has a lower elastic modulus than the tab lead, the electrode material layer is more likely to deform than the tab lead. Moreover, since the thickness of the electrode material layer in the orthogonal direction is greater than or equal to the thickness of the tab lead, a difference in thickness between the electrode material layer and the tab lead can be inhibited from being introduced when the electrode material layer and the tab lead are deformed by the first electrode being wound.

In the above the power storage cell in which the electrode material layer has a lower elastic modulus than the tab lead, preferably, the cushioning has a lower elastic modulus than the electrode material layer. When the first electrode is unfurled in the form of sheet, the thickness of the cushioning in the orthogonal direction is greater than or equal to the thickness of the electrode material layer in the orthogonal direction. With this configuration, since the cushioning has a lower elastic modulus than the electrode material layer, the cushioning is more likely to deform than the electrode material layer. Moreover, since the thickness of the cushioning in the orthogonal direction is greater than or equal to the thickness of the electrode material layer, a difference in thickness between the cushioning and the electrode material layer can be inhibited from being introduced when the cushioning and the electrode material layer are deformed by the first electrode being wound.

In the above the power storage cell in which the cushioning has a lower elastic modulus than the tab lead, preferably, when the first electrode, the second electrode, and the separator are wound together, an absolute value of a difference between a thickness of the cushioning in a radial direction of the wound electrode assembly and a thickness of the tab lead in the radial direction is less than or equal to a thickness of the current collector in the radial direction. With this configuration, the wound electrode assembly can have less unevenness, as compared to the difference being greater than the thickness of the current collector.

In the power storage cell according to the aspect of the present disclosure, preferably, the uncoated portion is disposed on an end portion of the current collector in a winding direction of the wound electrode assembly. With this configuration, unevenness can be inhibited from being formed on an end portion of the wound electrode assembly.

In this case, preferably, the cushioning includes an adhesive. With this configuration, on an end portion of the wound electrode assembly, the first electrode can be readily adhered (secured) to a member (e.g., the separator) that is adjacent to the first electrode in the radial direction.

In the power storage cell according to the aspect of the present disclosure, preferably, the uncoated portion extends in the axial direction in which the winding axis extends. The cushioning extends along the uncoated portion extending in the axial direction. With this configuration, since the cushioning is provided in a large area in the axial direction, the wound electrode assembly can be inhibited from forming unevenness.

According to the present disclosure, a local pressure can be inhibited from being applied to the wound electrode assembly which includes the tab lead.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view showing a configuration of a power storage cell according to an embodiment.

FIG. 2 is a schematic perspective view showing a configuration of a wound electrode assembly according to the embodiment.

FIG. 3 is a plan view showing a configuration of a positive plate according to the embodiment.

FIG. 4 is a plan view showing a configuration of a negative plate according to the embodiment.

FIG. 5 is a diagram showing a relationship between a positive tab lead, a positive electrode mixture layer, and the elastic modulus of an adhesive.

FIG. 6 is a cross-sectional view of the positive plate, taken along VI-VI line of FIG. 3.

FIG. 7 is a partially enlarged, cross-sectional view of a wound electrode assembly.

FIG. 8 is a plan view (a first view) showing a configuration of the positive plate according to a variation of the embodiment.

FIG. 9 is a plan view showing a configuration of the negative plate according to the variation of the embodiment.

FIG. 10 is a plan view (a second view) showing a configuration of the positive plate according to a variation of the embodiment.

FIG. 11 is a plan view (a third view) showing a configuration of the positive plate according to a variation of the embodiment.

### DESCRIPTION OF THE PREFERRED EMBODIMENTS

Hereinafter, an embodiment according to the present disclosure will be described, with reference to the accompanying drawings. Note that like reference signs are used to refer to like or corresponding parts in the drawings, and the description thereof will not be repeated.

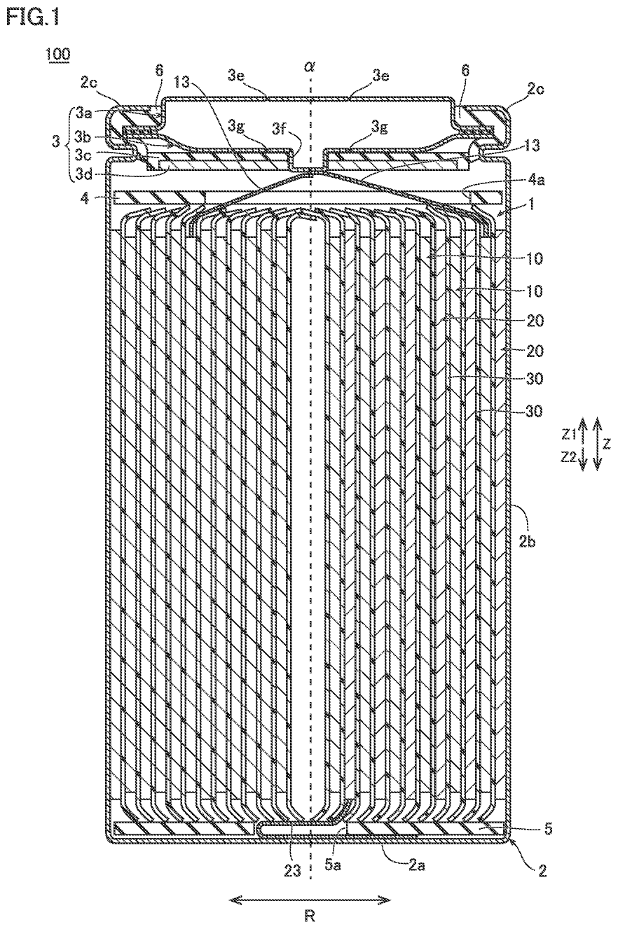

FIG. 1 is a cross-sectional view showing a general configuration of a power storage cell 100 according to an embodiment of the present disclosure. The power storage cell 100 is, for example, a lithium-ion battery that is mounted on a vehicle. Note that the application and type of the power storage cell 100 are not limited thereto.

The power storage cell 100 includes a wound electrode assembly 1, a case 2, a current interrupt device (CID) 3, a positive-side insulating plate 4, a negative-side insulating plate 5, and an insulating layer 6.

The wound electrode assembly 1 is accommodated in the case 2. The case 2 has a cylindrical shape. In other words, the power storage cell 100 is a cylindrical battery. The case 2 is formed of copper or aluminum, for example.

The wound electrode assembly 1 includes positive plates 10, negative plates 20, and separators 30. The separator 30 is disposed between the positive plate 10 and the negative plate 20. The separator 30 separates the positive plate 10 and the negative plate 20, while allowing ions (e.g., lithium-ions) to traverse between the positive plate 10 (a positive active material) and the negative plate 20 (a negative active material). The wound electrode assembly 1 is configured of a group of electrode plates in which the positive plate 10 and the negative plate 20 are wound via the separator 30. Note that the positive plate 10 and the negative plate 20 are one example of a “first electrode” and a “second electrode,” respectively, according to the present disclosure.

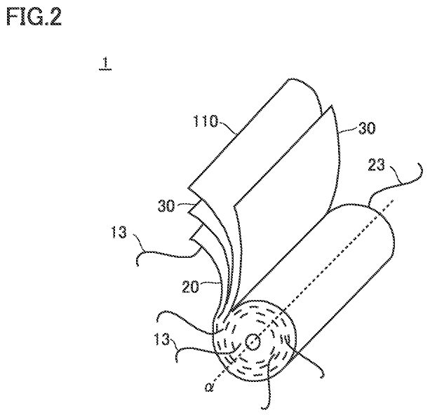

As shown in FIG. 2, the wound electrode assembly 1 configured of the positive plate 10, the negative plate 20, and the separator 30 which are wound about a winding axis a of the wound electrode assembly 1. In FIG. 2, the wound electrode assembly 1 is shown, being slightly unwound so that the wound state of the wound electrode assembly 1 is intelligible.

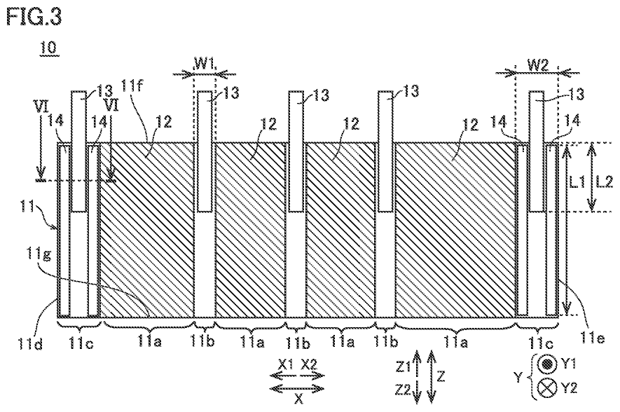

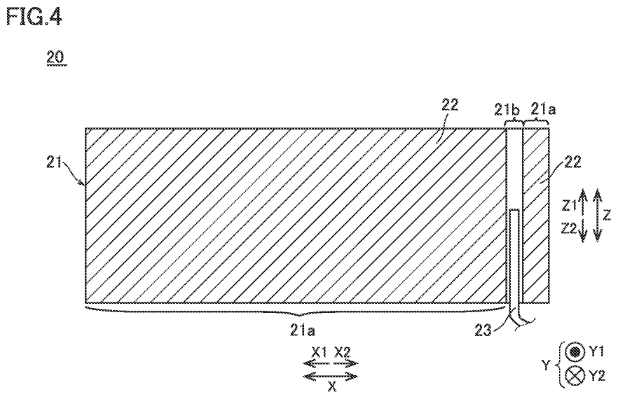

The positive plate 10 includes a positive current collector 11 (see FIG. 3), a positive electrode mixture layer 12 (see FIG. 3), multiple positive electrode tab leads 13 (five in the present embodiment), and an adhesive 14 (see FIG. 3). The negative plate 20 includes a negative current collector 21 (see FIG. 4), a negative electrode mixture layer 22 (see FIG. 4), and a negative electrode tab lead 23. Note that FIG. 1 shows only two positive electrode tab leads 13. The adhesive 14 and the positive electrode tab lead 13 are one example of a “cushioning” and a “tab lead,” respectively, according to the present disclosure. The positive current collector 11 and the positive electrode mixture layer 12 are one example of a “current collector” and an “electrode material layer,” respectively, according to the present disclosure.

Referring, again, to FIG. 1, the positive-side insulating plate 4 is accommodated in the case 2. The positive-side insulating plate 4 insulates the wound electrode assembly 1 (the negative plate 20 and the separator 30) from the case 2. The positive-side insulating plate 4 covers the positive current collector 11, the negative plate 20, and the separator 30 from Z1 side.

The positive-side insulating plate 4 has a through hole 4a. The positive electrode tab lead 13 passes through the through hole 4a and is in contact with a conductive film 3b described below. This electrically connects the positive electrode tab lead 13 and the conductive film 3b.

One of the positive electrode tab leads 13 is in contact with (soldered to) the conductive film 3b, and a remaining number of positive electrode tab leads 13 are soldered to the positive electrode tab lead 13 that is in contact with the conductive film 3b. Note than all the positive electrode tab leads 13 may be soldered to the conductive film 3b.

The negative-side insulating plate 5 is accommodated in the case 2. The negative-side insulating plate 5 insulates the wound electrode assembly 1 (the positive plate 10 and the separator 30) from the case 2. The negative-side insulating plate 5 covers the positive plate 10, the negative current collector 21, and the separator 30 from Z2 side.

The negative-side insulating plate 5 has a through hole 5a. The negative electrode tab lead 23 passes through the through hole 5a and is in contact with a bottom 2a of the case 2. This electrically connects the negative electrode tab lead 23 and the bottom 2a of the case. As a result, the side surface 2b of the case 2 in contact with the bottom 2a of the case 2 is negatively charged. Note that the side surface 2b is in contact with the negative current collector 21 of the negative plate 20 on the outermost periphery of the wound electrode assembly 1.

The CID 3 is an element that interrupts the current path, using an increase of the internal cell pressure caused by a gas generated due to overcharging of the power storage cell 100. The CID 3 seals the opening in the case 2 on Z1 side. The CID 3 has an external cap 3a, a conductive film 3b, a gasket 3c, and a bottom disk 3d.

The external cap 3a has a function as an external terminal by being electrically connected to an external busbar (not shown). The external cap 3a has a weakened portion 3e (a thin portion). As the internal pressure of the case 2 increases, the external cap 3a breaks, starting from the weakened portion 3e. This promptly exhausts the gas out of the case 2.

The conductive film 3b seals the opening in the case 2 on Z1 side. The conductive film 3b includes a projection 3f projecting toward the wound electrode assembly 1 side (Z2 side). The projection 3f is in contact with the positive electrode tab lead 13. This causes the conductive film 3b to be positively charged. The conductive film 3b is also electrically connected to the external cap 3a. This causes the external cap 3a to be positively charged as well. Note that the projection 3f passes through the gasket 3c and the bottom disk 3d.

Similarly to the external cap 3a, the conductive film 3b includes a weakened portion 3g (a thin portion). As the internal pressure of the case 2 increases, the conductive film 3b breaks, starting from the weakened portion 3g. If the internal pressure increases and the conductive film 3b breaks, the conductive film 3b and the positive electrode tab lead 13 are no longer in contact. As a result, the conductive film 3b is no longer positively charged, and the external cap 3a is no longer positively charged either. As a result, charging of and discharging from the power storage cell 100 are stopped.

The case 2 includes a crimp 2c that is crimped to the outer periphery of the external cap 3a. The insulating layer 6 insulates the crimp 2c from the external cap 3a (and the conductive film 3b).

FIG. 3 is a diagram of the positive plate 10 being unfurled in a form of sheet, as viewed from Y1 side. Y direction is a direction orthogonal to the positive current collector 11 being unfurled in a form of sheet. The positive current collector 11 has a rectangular shape having the long sides extending in X direction and the short sides extending in Z direction. Note that X direction is one example of a “winding direction” according to the present disclosure. Z direction is one example of an “axial direction” according to the present disclosure. Y direction is one example of an “orthogonal direction” according to the present disclosure. Note that Y direction corresponds to R direction of FIG. 1. R direction is one example of a “radial direction” according to the present disclosure.

As shown in FIG. 3, a portion of the positive current collector 11 is coated with the positive electrode mixture layer 12 (the hatched portions). In other words, the positive current collector 11 includes a coated portion 11a that is coated with the positive electrode mixture layer 12 and uncoated portions 11b and 11c that are not coated with the positive electrode mixture layer 12. Note that the uncoated portion 11c is one example of an “uncoated portion” according to the present disclosure.

In the example of FIG. 3, the uncoated portion 11c is disposed on each of the X1-side end portion 11d and the X2-side end portion 11e of the positive current collector 11. Three uncoated portions 11b are disposed apart from each other in X direction between the end portion 11d and the end portion 11e. The coated portion 11a is disposed between the uncoated portion 11c and the uncoated portion 11b and between the uncoated portions 11b. In the present embodiment, X1 side and X2 side will be referred to as a winding end side and a winding start side, respectively, for the wound electrode assembly 1.

For example, aluminum is used for the positive current collector 11. The positive electrode mixture layer 12 is formed by coating a surface of the positive current collector 11 with a cathode slurry and drying. The cathode slurry is prepared by mixing the materials (such as a positive active material and a binder) of the positive electrode mixture layer 12 and a solvent. The positive electrode mixture layer 12 is appressed to the separator 30 (see FIG. 1). The positive electrode mixture layer 12 has a thickness greater than or equal to 0.1 μm and less than or equal to 1000 μm, for example.

The three uncoated portions 11b and the two uncoated portions 11c each extend along Z direction. Each uncoated portion 11b has a width W1 in X direction. Each uncoated portion 11c has a width W2 in X direction. The width W2 of the uncoated portion 11c is greater than the width W1 of the uncoated portion 11b.

The positive electrode tab lead 13 is disposed on each of the three uncoated portions 11b and the two uncoated portions 11c. The positive electrode tab lead 13 projects from the positive current collector 11 in the axial direction (to Z1 side). The positive electrode tab lead 13 is disposed on the center of each uncoated portion 11b and each uncoated portion 11c in X direction.

Here, in a conventional power storage cell, the portion of the current collector where the lead is disposed may have an unevenness formed due to the thickness of the lead. In this case, when the wound electrode assembly is confined in a case or the like, a local pressure may be applied to the wound electrode assembly due to the unevenness of the wound electrode assembly.

Thus, in the present embodiment, the adhesives 14 are disposed adjacent to the positive electrode tab lead 13 on the uncoated portion 11c. Specifically, on the uncoated portion 11c, the adhesive 14 is disposed on each of X1 side and X2 side of the positive electrode tab lead 13. In other words, the positive electrode tab lead 13 is disposed, on the uncoated portion 11c, sandwiched between two adhesives 14 in X direction.

The adhesives 14 extend along the uncoated portion 11c (the positive electrode tab lead 13) that is extending along Z direction. In other words, the adhesives 14 are disposed on the surface of the uncoated portion 11c, extending in Z direction.

Specifically, the adhesive 14 extends from proximate an end 11f of the positive current collector 11 on Z1 side to proximate an end 11g of the positive current collector 11 on Z2 side. The adhesive 14 has a length L1 in Z direction, which is greater than a length L2, in Z direction, of the portion (overlapping the uncoated portion 11c) of the positive electrode tab lead 13 disposed on the uncoated portion 11c. In the example of FIG. 3, the length L1 is at least twice the length L2. Note that the adhesive 14 may extend to the end 11f (11g).

FIG. 4 is a diagram of the negative plate 20 being unfurled in a form of sheet, as viewed from Y1 side. As shown in FIG. 4, similarly to the positive current collector 11, the negative current collector 21 has a rectangular shape having the long sides extending in X direction and the short sides extending in Z direction.

For example, copper foil is used for the negative current collector 21. The negative electrode mixture layer 22 is formed by coating a surface of the negative current collector 21 with an anode slurry and drying. The anode slurry is prepared by mixing the materials (such as a negative active material and a binder) of the negative electrode mixture layer 22 and a solvent. The negative electrode mixture layer 22 is appressed to the separator 30 (see FIG. 1). The negative electrode mixture layer 22 has a thickness greater than or equal to 0.1 μm and less than or equal to 1000 μm, for example.

A portion of the negative current collector 21 is coated with the negative electrode mixture layer 22. In other words, the negative current collector 21 includes a coated portion 21a that is coated with the negative electrode mixture layer 22 and an uncoated portion 21b that is not coated with the negative electrode mixture layer 22. The negative electrode tab lead 23 is disposed on the uncoated portion 21b. The negative electrode tab lead 23 projects from the negative current collector 21 in the axial direction (Z2 side).

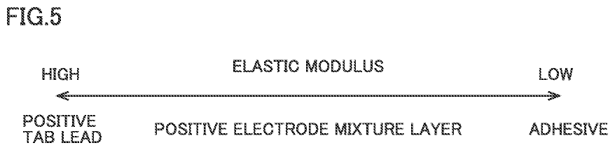

FIG. 5 is a diagram showing a relationship between the positive electrode tab lead 13, the positive electrode mixture layer 12, and the elastic modulus of the adhesive 14. As shown in FIG. 5, the positive electrode tab lead 13, the positive electrode mixture layer 12, and the adhesive 14 are in the order, starting from the highest elastic modulus to the lowest elastic modulus. In other words, the positive electrode tab lead 13, the positive electrode mixture layer 12, and the adhesive 14 are in the order, starting from the most unlikely to deform to the least unlikely to deform.

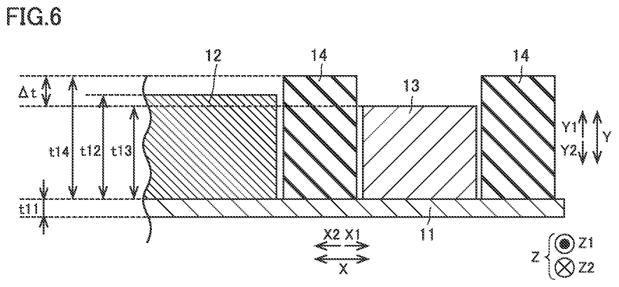

FIG. 6 is a cross-sectional view of the positive plate 10, taken along VI-VI line of FIG. 3. As shown in FIG. 6, the positive current collector 11 has a thickness t11 in Y direction. The positive electrode mixture layer 12 has a thickness t12 in Y direction. The positive electrode tab lead 13 has a thickness t13 in Y direction. The adhesive 14 has a thickness t14 in Y direction. Note that the thickness t12 of the positive electrode mixture layer 12, the thickness t13 of the positive electrode tab lead 13, and the thickness t14 of the adhesive 14 are greater than the thickness t11 of the positive current collector 11.

The thickness t14 of the adhesive 14 is greater than the thickness t12 of the positive electrode mixture layer 12 (t14>t12). The thickness t12 of the positive electrode mixture layer 12 is greater than the thickness t13 of the positive electrode tab lead 13 (t12>t13). In other words, the adhesive 14, the positive electrode mixture layer 12, and the positive electrode tab lead 13 are in the order, starting from the greatest thickness to the least thickness (t14>t12>t13). Accordingly, they are configured so that a greater the thickness, the lower the elastic modulus (more likely to deform).

A difference Δt between the thickness t14 of the adhesive 14 and the thickness t13 of the positive electrode tab lead 13 is greater than the thickness t11 of the positive current collector 11 (Δt>t11). The difference Δt is smaller than the thickness t13 of the positive electrode tab lead 13 (Δt<t13). For example, the difference Δt is no greater than one-third of the thickness t13 of the positive electrode tab lead 13 (Δt≤t13/3). Note that the difference Δt may be less than or equal to the thickness t11 of the positive current collector 11. The value, one-third, is merely by way of example, and the present disclosure is not limited thereto.

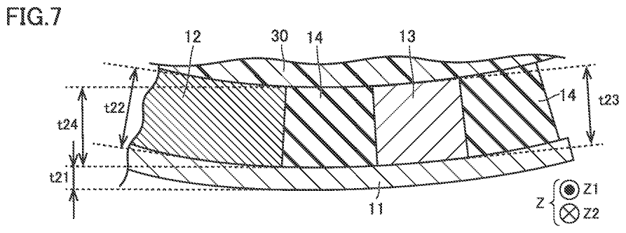

FIG. 7 is a cross-sectional view of the positive plate 10, the separator 30, and the negative plate 20 being wound together. In this state, due to the difference in elastic modulus noted above, the adhesive 14, the positive electrode mixture layer 12, and the positive electrode tab lead 13 are in the order, starting from the largest amount of deformation to the least amount of deformation. Due to this, the difference between the thickness t24 of the adhesive 14 in the radial direction (R direction) and the thickness t23 of the positive electrode tab lead 13 in the radial direction is less than the thickness t21 of the positive current collector 11 in the radial direction.

In the example of FIG. 7, the thickness t24 of the adhesive 14, the thickness t23 of the positive electrode tab lead 13, and the thickness t22 of the positive electrode mixture layer 12 in the radial direction are approximately equal. Accordingly, the above difference is approximately zero. Note that the difference may be greater than zero and less than the thickness t21 of the positive current collector 11.

As described above, in the present embodiment, the adhesives 14 are disposed at the locations adjacent to the positive electrode tab lead 13 on the uncoated portion 11c. This can prevent a space, where no member is disposed, from being formed at the locations adjacent to the positive electrode tab lead 13. As a result, unevenness can be inhibited from being formed at the locations adjacent to the positive electrode tab lead 13. This can inhibit a local pressure from being applied to the wound electrode assembly 1 due to the unevenness.

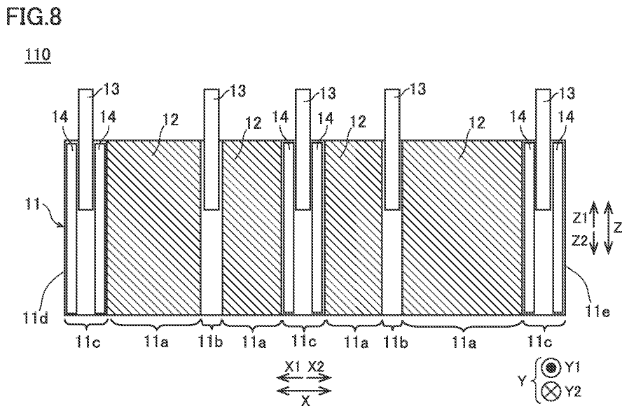

In the above embodiment, the adhesives 14 are disposed on the uncoated portions 11c on the X1-side end portion 11d and the X2-side end portion 11e of the positive current collector 11. However, the present disclosure is not limited thereto. The uncoated portions 11c may be disposed on portions of the positive current collector 11, other than those on the end portion 11d and the end portion 11e. In a positive plate 110 shown in FIG. 8, an uncoated portion 11c, on which the positive electrode tab lead 13 and the adhesives 14 are disposed, is provided between the end portion 11d and the end portion 11e (e.g., the center portion) of the positive current collector 11. Moreover, although not shown, the uncoated portion 11c may be disposed on only one of the X1-side end portion 11d and the X2-side end portion 11e of the positive current collector 11. Note that the positive plate 110 is one example of a “first electrode” according to the present disclosure.

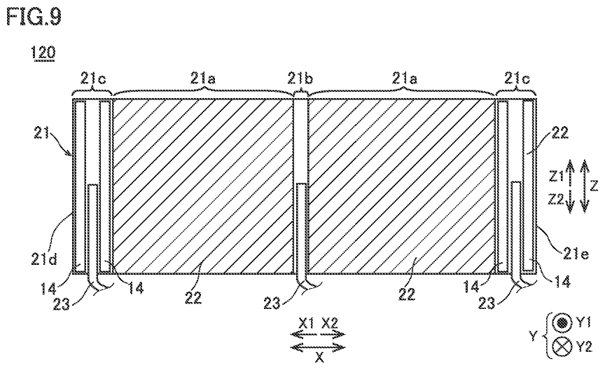

In the above embodiment, the adhesives 14 are disposed on the uncoated portion 11c of the positive current collector 11. However, the present disclosure is not limited thereto. The adhesives 14 may be disposed on a negative current collector. In the example of FIG. 9, the negative current collector 21 of the negative plate 120 includes uncoated portions 21c, in addition to the coated portions 21a and the uncoated portion 21b. The negative electrode tab lead 23 and the adhesives 14 are disposed on the uncoated portion 21c. The negative electrode tab lead 23 on the uncoated portion 21c is sandwiched between the two adhesives 14. Note that the uncoated portion 21c is disposed on each of an end portion 21d of the negative current collector 21 on X1 side and an end portion 21e of the negative current collector 21 on X2 side. The negative plate 120 is one example of a “second electrode” according to the present disclosure.

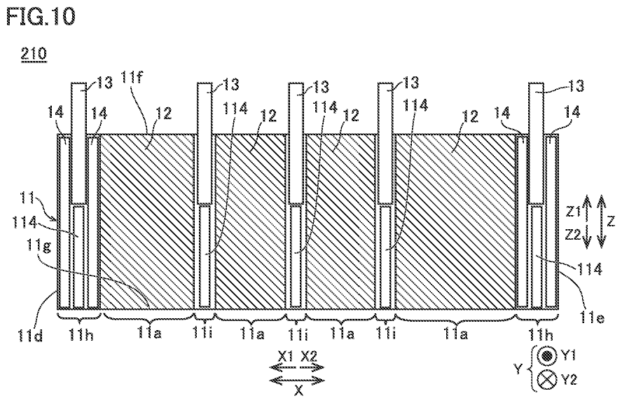

In the above embodiment, the adhesives 14 are adjacent to the positive electrode tab lead 13 in X direction. However, the present disclosure is not limited thereto. On an uncoated portion 11h of the positive plate 210 shown in FIG. 10, an adhesive 114 is disposed adjacent to the positive electrode tab lead 13 on Z2 side of the positive electrode tab lead 13, in addition to the adhesives 14 being disposed on opposite sides of the positive electrode tab lead 13 in X direction. On an uncoated portion 11i, an adhesive 114 is disposed adjacent to the positive electrode tab lead 13 on Z2 side of the positive electrode tab lead 13. Note that the adhesives 14 and 114 on the uncoated portion 11h may be combined and disposed as one adhesive. The positive plate 210 and the adhesive 114 are one example of a “first electrode” and a “cushioning,” respectively, according to the present disclosure.

In the above embodiment, the thickness t14 of the adhesive 14 is greater than the thickness t13 of the positive electrode tab lead 13. However, the present disclosure is not limited thereto. The thickness t14 of the adhesive 14 may be equal to the thickness t13 of the positive electrode tab lead 13. Moreover, the thickness t12 of the positive electrode mixture layer 12 may be equal to the thickness t13 of the positive electrode tab lead 13. The thickness t14 of the adhesive 14 may be equal to the thickness t12 of the positive electrode mixture layer 12.

In the above embodiment, the adhesives 14 are disposed on the uncoated portion 11c. However, the present disclosure is not limited thereto. A non-adhesive cushioning (e.g., a rubber) may be disposed on the uncoated portion 11c.

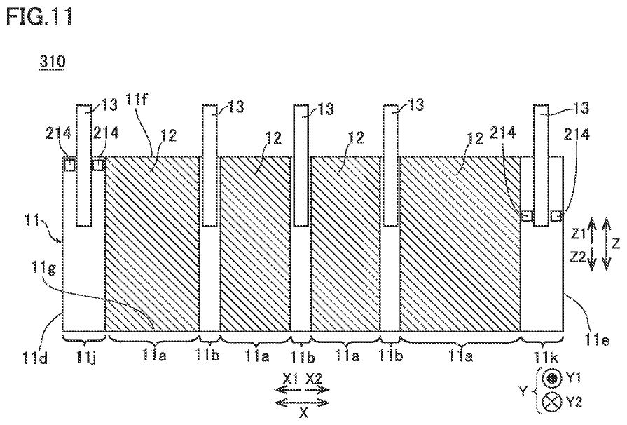

In the above embodiment, the adhesive 14 extends in the axial direction along the uncoated portion 11c. However, the present disclosure is not limited thereto. For example, a positive plate 310 shown in FIG. 11 includes adhesives 214 disposed only on the Z1-side end portion of the uncoated portion 11j. Moreover, adhesives 214 are disposed proximate the center portion of an uncoated portion 11k in Z direction. Note that the positive plate 310 and the adhesive 214 are one example of a “first electrode” and a “cushioning,” respectively, according to the present disclosure.

In the above embodiment, multiple positive electrode tab leads 13 are provided. However, the present disclosure is not limited thereto. Only one positive electrode tab lead 13 may be provided.

In the above embodiment, two adhesives 14 are disposed on the uncoated portion 11c. However, the present disclosure is not limited thereto. Only one adhesive 14 may be disposed on the uncoated portion 11c.

Note that the embodiment and the respective variations thereof may be combined.

Although the embodiment according to the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage cell, comprising:
a wound electrode assembly which includes a first electrode, a second electrode, and a separator disposed between the first electrode and the second electrode; and
a case accommodating the wound electrode assembly, wherein
the wound electrode assembly is configured of the first electrode, the second electrode, and the separator which are wound about a winding axis,
the first electrode includes:
a current collector;
an electrode material layer with which a portion of the current collector is coated;
a tab lead projecting from the current collector in an axial direction of the wound electrode assembly; and
a cushioning, wherein
the current collector includes an uncoated portion that is not coated with the electrode material layer,
the tab lead is disposed on the uncoated portion, and
the cushioning is disposed adjacent to the tab lead on the uncoated portion.

2. The power storage cell according to claim 1, wherein
the cushioning has a lower elastic modulus than the tab lead, and
when the first electrode is unfurled in a form of sheet, a thickness of the cushioning in an orthogonal direction orthogonal to the current collector is greater than or equal to a thickness of the tab lead in the orthogonal direction.

3. The power storage cell according to claim 2, wherein
the electrode material layer has a lower elastic modulus than the tab lead, and
when the first electrode is unfurled in the form of sheet, a thickness of the electrode material layer in the orthogonal direction is greater than or equal to the thickness of the tab lead in the orthogonal direction.

4. The power storage cell according to claim 3, wherein
the cushioning has a lower elastic modulus than the electrode material layer, and
when the first electrode is unfurled in the form of sheet, the thickness of the cushioning in the orthogonal direction is greater than or equal to the thickness of the electrode material layer in the orthogonal direction.

5. The power storage cell according to claim 2, wherein
when the first electrode, the second electrode, and the separator are wound together, an absolute value of a difference between a thickness of the cushioning in a radial direction of the wound electrode assembly and a thickness of the tab lead in the radial direction is less than or equal to a thickness of the current collector in the radial direction.

6. The power storage cell according to claim 1, wherein
the uncoated portion is disposed on an end portion of the current collector in a winding direction of the wound electrode assembly.

7. The power storage cell according to claim 6, wherein
the cushioning includes an adhesive.

8. The power storage cell according to claim 1, wherein
the uncoated portion extends in the axial direction in which the winding axis extends, and
the cushioning extends along the uncoated portion extending in the axial direction.
